(19) United States
(12) Patent Application Publication
(10) Pub. No.: US 2008/0180069 A1
(43) Pub. Date: Jul. 31, 2008

(54) BATTERY-LESS POWER GENERATION CONTROL SYSTEM AND STRADDLE TYPE VEHICLE HAVING THE SAME

(75) Inventor: Kazuo Sato, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR ELECTRONICS KABUSHIKI KAISHA, Shizuoka-ken (JP)

(21) Appl. No.: 12/017,697

(22) Filed: Jan. 22, 2008

(30) Foreign Application Priority Data
Jan. 31, 2007 (JP) 2007-022128

(51) Int. Cl. H02P 9/00

(52) U.S. Cl. 322/27; 322/36

(57) ABSTRACT

A battery-less power generation control system that maintains fuel economy and minimizes losses in horsepower generated by engine operation includes a magnet-type generator driven by an internal combustion engine and a controller for rectifying the alternating current generated by the generator to a direct current, the controller supplying the generated direct current to electric equipment. The controller includes a rectifying section for converting the alternating current generated by the generator to direct current, and a control section for controlling the generated current output by the rectifying section. The battery-less power generation control system detects a load current flowing through the electric equipment and the control section controls the rectifying section so that the generated current is generally equal to the load current.

### CROSS-REFERENCE TO RELATED APPLICATIONS

This application is based upon and claims priority under 35 U.S.C. § 119 to Japanese patent application Serial No. 2007-022128, filed Jan. 31, 2007, the entire contents of which is hereby incorporated by reference.

### BACKGROUND OF THE INVENTION

1. Field of the Invention

The present invention relates to a power generation control system. Embodiments of the invention are disclosed herein as a battery-less power generation control system in which alternating current is generated by a magnet type generator using an internal combustion engine as a drive source, the alternating current is rectified to direct current by generated current control means, and the direct current is supplied to electric equipment, and a straddle type vehicle having the battery-less power generation control system that can be applied to a kick starter type motorcycle or the like.

2. Description of the Related Art

FIG. 6 is a circuit diagram of a conventional power generation control system for a kick starter type motorcycle or the like. The power generation control system is structured as follows: three-phase alternating current is generated by a magnet type generator 11 using an internal combustion engine (not shown) as a drive source, the alternating current is rectified to direct current by a regulator 12, and the generated current is supplied to electric equipment 14 (e.g., a head lamp 14a, a brake lamp 14b and other electric devices 14c). Additionally, current generated from a battery 13 that is disposed parallel to the regulator 12 is also supplied to the electric equipment 14.

FIG. 7(A) illustrates the fluctuation of a generated current Ix relative to the fluctuation of a load current Iy in the power generation control system 10. FIG. 7(B) illustrates the fluctuation of a voltage of the battery relative to the fluctuation of the load current Iy.

For example, the load current Iy is slightly larger than the generated current Ix in a range of [a] through [b] of FIG. 7(A). Corresponding to this state, a discharge current Id is discharged from the battery 13 in a range of [a′] through [b′] of FIG. 7(B) and the battery voltage gradually falls.

Next, the load current Iy becomes smaller than the generated current Ix to slightly fall below the generated current Ix in a range of [b] through [c] of FIG. 7(A). The generated current Ix, however, does not change and does not follow the load current Iy. Corresponding to this state, the battery is charged with a charge current Iq in a range of [b′] through [c′] of FIG. 7(B) and the battery voltage gradually rises.

Next, the load current Iy becomes smaller than the generated current Ix to greatly fall below the generated Ix in a range of [c] through [e] of FIG. 7(A). The generated current Ix, however, does not follow and does not change for awhile. Therefore, a surplus of the generated current Iq flows into the battery 13 to charge the battery 13 and the battery voltage rapidly rises. Accordingly, the supply of the generated current Ix is stopped at point [d].

Then, the battery 13 greatly discharges at point [d′] corresponding to the point [d]; thereby, the load current Iy is supplied to the electric equipment 14. When the battery voltage falls to point [e′], the supply stop of the generated current Ix to the electric devices 14 ends at the point [e]. The supply of the generated current Ix restarts at the point [e]. When the generated current Ix again exceeds the load current Iy, the surplus of the charge current Iq flows into the battery 13 to charge the battery 13. The battery voltage thus rises.

The time slightly elapses from the point [e] and the generated current Ix greatly exceeds the load current Iy at point [f]. Then, the battery 13 greatly discharges again at point [f′] and the battery voltage starts to fall.

The generated current Ix and the load current Iy fluctuate in the correlation discussed above. According to the power generation control system having the regulator 12 and the battery 13 and applied to the kick starter type motorcycle or the like, the generated current is not able to smoothly follow the fluctuation of the load current.

Therefore, conventional straddle type vehicles such as a kick starter type motorcycle uses a capacitor instead of the battery. The electric power obtained by a kicking operation is instantly charged to the capacitor and discharged to be output to an ignition system. Meanwhile, the electric power supplied to lamps such as, for example, a head lamp can be obtained from a generator which is driven by the internal combustion engine to generate the electric power when the vehicle runs.

Japanese Publication JP 07-103112 discloses an electrical equipment starting load reduction control device for a battery-less vehicle. The battery-less vehicle is a vehicle in which electrical component loads are driven by the power generated from a generator driven by the rotation output of an engine, and also an ignition system operated by the rotation output. According to the control device, load feeding control means monitors an engine speed based upon an output signal from a pick-up coil. When the engine speed reaches a preset engine speed, switching means placed between an output of the generator and electric loads other than the ignition system is closed so that the power generated by the generator is supplied to the other loads.

In the control device of JP 7-103112, a rectifying/regulating section (regulating rectifier) has a rectifying circuit for rectifying alternating voltage and an output voltage regulating circuit for regulating the generated output voltage. Generally, however, the output voltage is regulated regardless of the current necessary for the other loads. Hence, there is some risk that a current which exceeds the current necessary for the other loads flows through the circuit. If this occurs, the excess current needlessly flows through the circuit. Consequently, there can be other risks that the fuel economy deteriorates and some losses arise with the horsepower generated in accordance with the engine operation.

### SUMMARY OF THE INVENTION

In view of the circumstances noted above, an aspect of at least one of the embodiments disclosed herein is to provide a battery-less power generation control system that can supply sufficient current to electric equipment, that hardly raises any losses in the horsepower generated in accordance with the engine operation, and that can maintain good fuel economy, and also to provide a straddle-type vehicle having such a battery-less power generation control system suitable for a kick starter type motorcycle or the like.

In accordance with one aspect of the invention, a battery-less power generation control system is provided. The battery-less power generation control system comprises a magnet-type generator driven at least by an internal combustion engine, the magnet-type generator configured to generate an alternating current and a load current detecting sensor configured to detect a load current flowing through at least one electric device. The battery-less power generation control system also comprises a controller configured to rectify the generated alternating current to a generated direct current and to supply the generated direct current to the least one electric device, the controller comprising a rectifying section for converting the generated alternating current to the generated direct current and a control section for controlling the generated current output from the rectifying section, the control section configured to control the rectifying section so that the generated current output from the rectifying section is generally equal to the load current.

In accordance with another aspect of the invention, a method for operating a battery-less power generation system involves detecting a load current flowing through at least one electrical component, inputting the load current value into a controller, determining whether a current generated by a generator of the power generation system is equal to or greater than the load current value, determining whether a difference value calculated by subtracting the load current from the generated current is equal to or larger than a predetermined value if the generated current is equal to or greater than the load current value, and increasing a supply amount of the generated current if the generated current is smaller than the load current.

In accordance with still another aspect of the invention, a method for operating a battery-less power generation system is provided. The method comprises detecting a load current flowing through at least one electrical component, inputting the load current value into a controller, determining whether the current generated by a generator is equal to the load current, maintaining a supply amount of the generated current if the generated current is equal to the load current, and determining whether the generated current is larger than the load current if the generated current is not equal to the load current.

### BRIEF DESCRIPTION OF THE DRAWINGS

These and other features, aspects and advantages of the present inventions will now be described in connection with preferred embodiments, in reference to the accompanying drawings. The illustrated embodiments, however, are merely examples and are not intended to limit the inventions. The drawings include the following 8 figures

FIG. 1 is a circuit diagram of one embodiment of a battery-less power generation control system.

FIG. 2A is a diagram of one phase of a three-phase voltage waveform.

FIG. 2B is a diagram of one phase of a pulse-shaped phase angle control signal.

FIG. 2C is a diagram of one phase of an output current waveform corresponding to the phase angle control signal of FIG. 2B applied to the voltage waveform of FIG. 2A.

FIG. 2D is a diagram of another phase of an output current waveform.

FIG. 2E is a diagram of another phase of an output current waveform.

FIG. 2F is a diagram of a composite output current waveform including the three phases in FIGS. 2C-2E.

FIG. 3 is a flowchart showing execution processes of the control section, in accordance with one embodiment.

FIG. 4 is a graph showing fluctuations of the generated current and the load current in the battery-less power generation control system of FIG. 1.

FIG. 5 is a flowchart showing execution processes of a control section of another embodiment of a battery-less power generation control system.

FIG. 6 is a circuit diagram of a prior power generation control system for a conventional kick starter type motorcycle or the like.

FIG. 7(A) is a graph showing fluctuation of a generated current relative to fluctuation of a load current in the power generation control system of FIG. 6.

FIG. 7(B) is a graph showing the fluctuation of the battery voltage in the power generation control system of FIG. 6.

### DETAILED DESCRIPTION OF PREFERRED EMBODIMENTS

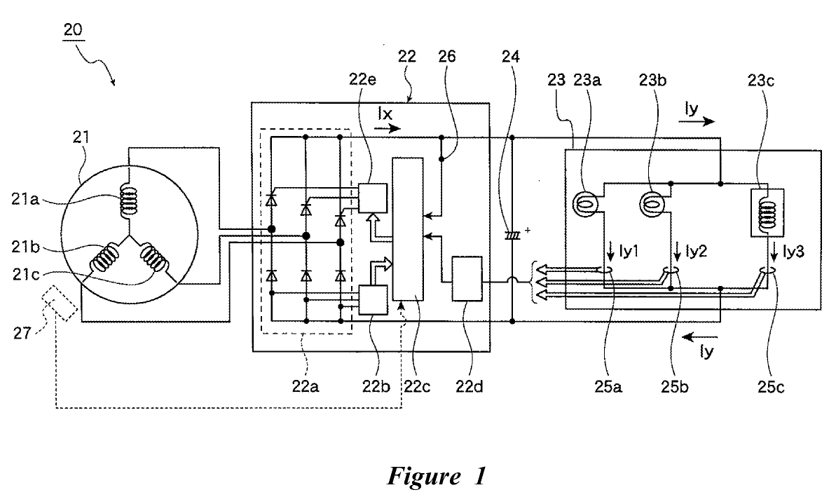

FIG. 1 shows one embodiment of a battery-less power generation control system 20, which can be used with a straddle type vehicle, such as, for example, a motorcycle or the like. However, the inventions disclosed herein are not limited to a so-called motorcycle-type two-wheel vehicle, but are applicable to other types of two-wheel vehicles. Moreover, the inventions disclosed herein are not limited to two-wheel vehicles, but may be used with other types of straddle-type vehicle. Furthermore, some aspects of the inventions disclosed herein are not limited to straddle-type vehicles, but can also be used with vehicles with side-by-side seating.

As shown in FIG. 1, the battery-less power generation control system 20 includes a magnet type generator 21, a generated-current controller 22, electric equipment 23, and a capacitor 24 disposed parallel to the electric equipment 23.

The magnet type generator (e.g., power generating body) 21 can be a three-phase alternating current generator driven by an engine (not shown), such as an internal combustion engine, in which permanent magnets (not shown) attached to a rotor rotate relative to a stator and stator coils generate electric power.

The electric equipment 23 can include a head lamp 23a, a brake lamp 23b and other electric devices 23c. Other electric devices 23c can include an ignition control controller, an engine control unit, an FI controller, a tail lamp, a stop lamp, a neutral indicator, a meter, an electrically operable pump, etc.

Load current detecting sensors 25a-25c, which can function as load current detecting means, can be attached to the head lamp 23a, the brake lamp 23b and the other electric devices 23c. The load current detecting sensors 25a-25c can detect individual load currents Iy1-Iy3 flowing through the electric equipment 23 and output detection signals to a load amount information calculating section 22d.

The generated-current controller 22 can include a rectifying section 22a, a phase detecting circuit 22b, a control section 22c, the load amount information calculating section 22d and a gate circuit 22e. In one embodiment, a micro-computer can be employed as the control section 22c.

The rectifying section 22a can be a circuit that converts an alternating current generated by the magnet-type generator (e.g., three-phase power generating body) 21 to a direct current. The rectifying section 22a can be structured in such a manner that circuits, in which diodes positioned upstream and thyristors positioned downstream are connected in series, are connected to each other using a three-phase bridge mixing circuitry. The alternating current induced in the respective stator coils 21a-21c can be input into a mid-point between the diodes and the thyristors, and the gates of the respective thyristors can be controlled to be turned on by a phase angle control current to output the generated current in a variable state. When a certain current passes through each gate of the respective thyristor, the anode and the cathode of the thyristor are connected (e.g., turned on) to each other. In order to halt the connection (e.g., turn off), an amount of the current flowing between the anode and the cathode needs to fall below a certain value. In this embodiment, each thyristor turns off in the process that the alternating current changes decrease toward zero.

Three-phased voltages of the rectifying section 22a are input into the phase detecting circuit 22b. The phase detecting circuit 22b can detect phase differences among the three-phased voltages. For example, the phase detecting circuit 22b can detect the phase of the voltage waveform. To determine the phase, the electric angle when the output voltage reaches a predetermined reference voltage can be defined as the origin to measure the phase, for example. More specifically, changing voltages are input per one phase. When the input voltage becomes a reference voltage when, for example, the voltage reaches a preset reference voltage given when the voltage starts rising, one pulse is output. It is satisfactory, if such operation is made for each one of the three phases. Additionally, in one embodiment, instead of the phase detecting circuit 22b, a phase detecting sensor (for example, a magnetic sensor) 27 can be provided proximate the magnet type generator 21 and a projection or the like can be provided to the rotor, whereby the phase detecting sensor can detect positions of the three stator coils.

In the illustrated embodiment, the capacitor 24 can compensate a small delay of the generated current relative to fluctuations of the load current, and during overshoot.

The load amount information calculating section 22d can calculate the total sum of current values detected by the load current detecting sensors (e.g., current sensors) 25a, 25b, 25c and can input an analog value or a digital value having a magnitude corresponding to the total sum to the control section 22c.

The battery-less power generation control system 20 can also include a generated current detecting sensor 26 for detecting a generated current Ix that is output from the rectifying section 22a. A detection signal detected by the generated current detecting sensor 26 is input into the control section 22c.

Signals corresponding to the three phases are input into the control section 22c from the phase detecting circuit 22b. The control section 22c, per one phase, sets a time at which a gate signal (e.g., a trigger signal) is output as a criterion for starting a count. The analog value or digital value that is the magnitude corresponding to the total sum Iy of the load current is input into the control section 22c via the load amount information calculating section 22d. Also, the generated current Ix is input into the control section 22c via the generated current detecting sensor 26. The control section 22c then calculates and determines power demand at proper timing to determine a count time. The control section 22c outputs a gate-signal-outputting-instructing-signal to the gate circuit 22e when the count time elapses.

The gate-signal-outputting-instructing-signal from the control section 22c is input into the gate circuit 22e. The gate circuit 22e outputs a trigger signal having a magnitude that can turn on the gate of each thyristor of the rectifying section 22a based upon the gate-signal-outputting-instructing-signal. Accordingly, the rectifying section 22a can be controlled in a phase angle control manner to increase or decrease the generated current Ix.

In the illustrated embodiment, the generated current Ix can also be input into the control section 22c in a feedback manner. Therefore, the control section 22c controls the power generation by comparing the generated current Ix and the load current Iy with each other to manage current requirement.

Information about a magnitude of the generated current Ix of the rectifying section 22a is input into the control section 22c, and information about the load current Iy is input into the control section 22c from the load amount information calculating section 22d. In one embodiment, the control section 22c can be structured to control the respective thyristors of the rectifying section 22a in the phase control manner to increase or decrease the generated current Ix so that the generated current Ix is always larger than the load current Iy by a predetermined amount (e.g., a preset amount).

The information about the magnitude of the generated current Ix output from the rectifying section 22a is input into the control section 22c. The control section 22c determines a magnitude of a difference value by subtracting the load current Iy from the generated current Ix, and determines the timing for outputting a pulse-shaped phase angle signal, using at least the detection signal of the output voltage phase of the magnet type generator 21 detected by the phase detecting circuit 22b as a criterion, and in accordance with the magnitude of the difference value. The control section 22c provides the phase signal to each thyristor of the rectifying section 22a to control the respective thyristors in the phase control manner so as to increase or decrease the generated current Ix that is larger than the load current Iy by the preset amount in the phase control manner.

More specifically, the control section 22c can be structured in such a manner that the control section 22c controls the thyristors of the rectifying section 22a to decrease the generated current Ix output if the difference value calculated by subtracting the load current Iy from the generated current Ix exceeds the preset amount. Additionally, the control section 22c controls the thyristors of the rectifying section 22a to maintain the generated current Ix output if the difference value is equal to or less than the preset amount and between the preset amount and zero. Further, the control section 22c controls the thyristors of the rectifying section 22a to increase the generated current if the different value is a negative value. Additionally, the predetermined or preset amount can be a small value where the generated current Ix is generally equal to or slightly greater than the load current Iy.

Thereby, the control section 22c, when the current requirement is small (for example, under an idling condition or a deceleration condition where the engine brake is activated), controls to increase the count time so that the generation of the generated current in the thyristors of the rectifying section 22a is small. Likewise, when the current requirement is large (for example, under an engine starting condition, a sudden acceleration condition and a high speed running condition), the control section 22c controls to shorten the count time so that the generation of the generated current in the thyristors of the rectifying section 22a is large.

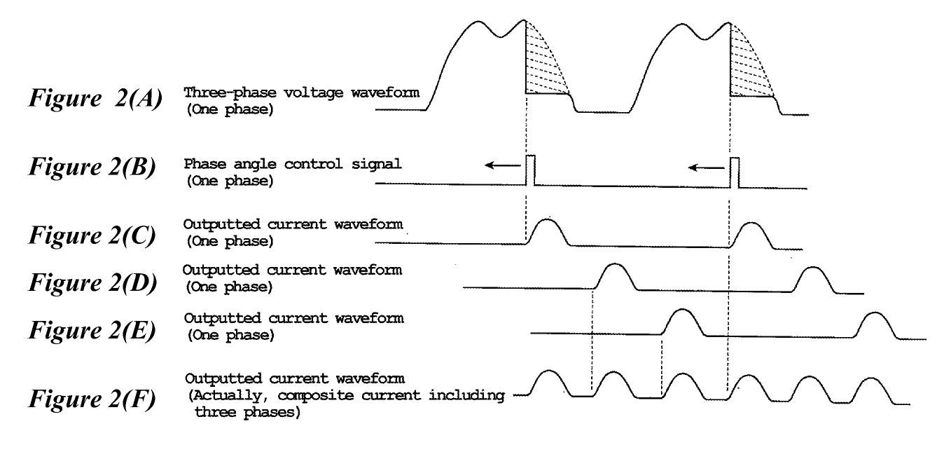

FIGS. 2A-F illustrate the relationship between the phase angle control for the thyristors with which the control section 22c rectifies the three-phase alternating current of the magnet type generator 21 to the generated current Ix that is the direct current and the output current.

The control section 22c detects respective voltages of the three phases of the magnet type generator 21 using the battery as the GND point. One phase output voltage is normally provided as a waveform voltage having two humps, like the output voltage waveform shown in FIG. 2(A). If, however, the pulse-shaped phase angle signal detected by the phase detecting circuit 22b and shown in FIG. 2(B) is input into the thyristor, the output voltage becomes a voltage having a waveform such that a portion thereof is cut away to the level of the battery voltage at a moment where the phase angle signal is input, and the output current shown in FIG. 2(C) flows from the thyristor. The output current flows corresponding to a portion of the one phase of the three-phase voltage waveform indicated by the hatching of FIG. 2(A). By combining three of the one phase output current to complete the three-phase (see FIGS. 2(C)-(E)), a composite output current including the three phases shown in FIG. 2(F) is generated. Because the control section 22c is structured to control the respective thyristors of the rectifying section 22a in a switching manner by increasing or decreasing the output numbers of the phase angle signals, the rectifying section 22a increases or decreases, in the phase angle control manner, the generated current Ix made by rectifying the generated current of the magnet type generator 21 to provide an output current.

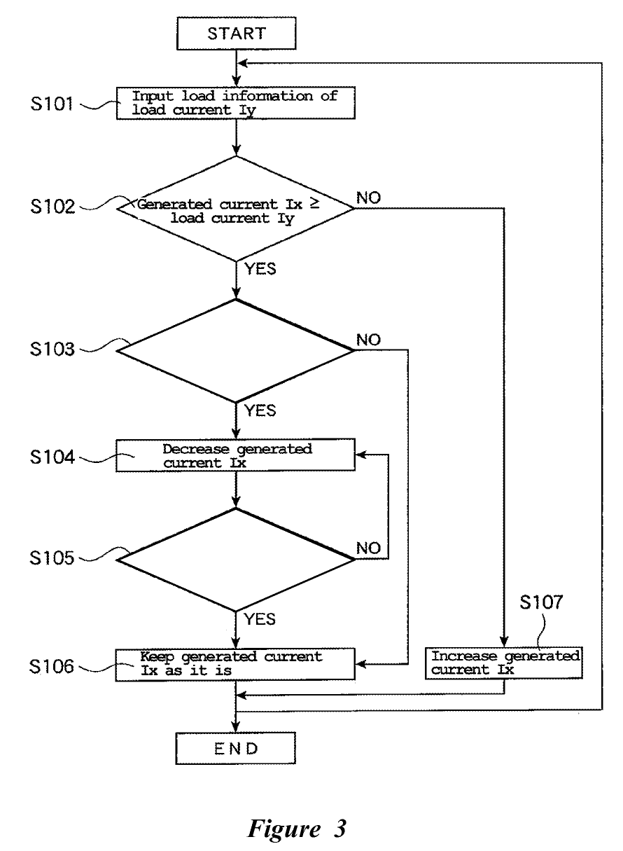

FIG. 3 is a flowchart showing execution processes of the control section 22c, in accordance with one embodiment.

First, the load current detecting sensor 25a-25c detects individual load currents Iy1-Iy3 flowing through the electrical equipment 23, and the load amount information calculating section 22d calculates a value of load current Iy summing up the individual load currents Iy1-Iy3 and inputs information of the load current Iy into the control section 22c (S101).

Next, the control section 22c determines whether the generated current Ix is equal to or larger than the load current Iy or not (S102). If the generated current Ix is larger than the load current Iy, the control section 22c determines whether a difference value made by subtracting the load current Iy from the generated current Ix is equal to or larger than the preset value (S103). If the generated current Ix is smaller than the load current Iy (S102), the control section 22c shifts the output of the phase angle signal to make the phase angle larger and outputs the shifted signal to each thyristor to increase the generated current Ix (S107). The clause “to increase the generated current Ix” means that the control section 22c shortens the count time that is set for outputting the trigger signal.

Next, at the step that the control section 22c determines whether a difference value made by subtracting the load current Iy from the generated current Ix is equal to or larger than the preset value (S103), if the determination is YES, the control section 22c shifts the output of the phase angle signal to make the phase angle smaller and outputs the shifted signal to each thyristor to decrease the generated current Ix (S104). If the determination is NO, the control section 22c keeps the outputting timing of the phase angle signal to maintain the phase angle as it is and outputs the signal to each thyristor to maintain the generated current Ix (S106). The clause “to decrease the generated current Ix” means that the control section 22c increases the count time that is set for outputting the trigger signal. The clause “to maintain the generated current Ix” means that the control section 22c maintains the count time that is set for outputting the trigger signal to be the same time.

The control section 22c, after decreasing the supply amount of the generated current Ix, determines whether the difference value made by subtracting the load current Iy from the generated current Ix is smaller than the preset value (S105). If the determination is YES, the control section 22c keeps the outputting timing of the phase angle signal to maintain the phase angle as it is and outputs the signal to each thyristor to maintain the generated current Ix (S106). If the determination is NO, the control section 22c returns to the step at which the generated current Ix is decreased (S104).

The control section 22c, after keeping the generated current Ix as it is (S106) or increasing the generated current Ix (S107), returns again to the step for inputting the load amount information 25 of the load current Iy (S101).

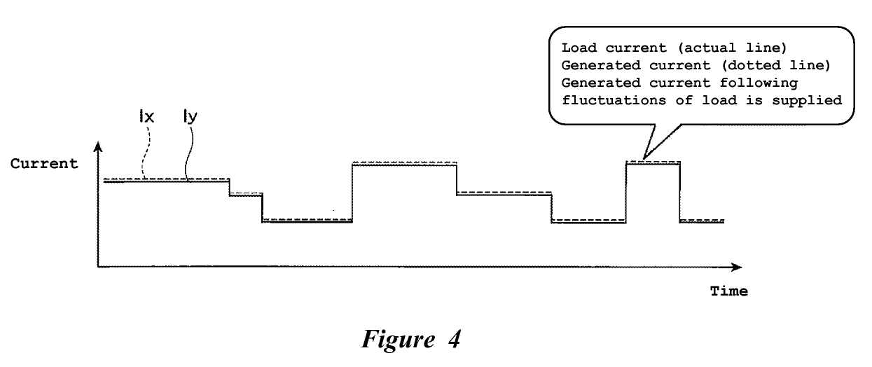

As described above, the generated current Ix is controlled in accordance with the load current Iy that fluctuates with time. FIG. 4 is a graph showing fluctuations of the generated current Ix and the load current Iy in this embodiment. In the illustrated embodiment, the generated current Ix increases and decreases in accordance with the fluctuation of the load current Iy so as to be always larger than the load current Iy by the predetermined (e.g., preset) amount.

According to this embodiment, the system controls the generated current Ix to be larger than the load current Iy by the predetermined (e.g., preset) amount and supplies the generated current Ix to the electric equipment 23. Accordingly, the fuel economy of the power generating system 10 does not deteriorate and losses are minimized with the horsepower generated in accordance with the engine operation. Also, the current does not needlessly flow through the electric equipment 23, and the system does not run short of the current. The use efficiency of the electric equipment 23 is thus maintained. Because the generated current Ix that is larger than the stable load current Iy by the predetermined (e.g., preset) amount is supplied to the electric equipment even without having any battery, the total weight of a straddle-type vehicle (e.g. a motorcycle) can be reduced if the system 20 is employed as its power generating system. Also, the storage space used to contain the battery in a conventional vehicle (e.g., motorcycle), can be used for another purpose as the system 20 is battery-less, and the overall cost of the system and vehicle can be reduced because the system 20 does not require a battery.

Another embodiment of a battery-less power generation control system can have the same circuit diagram as shown in FIG. 1, so that the description regarding the same structural portions will be omitted. However, the structure of the control section 22c differs between the two embodiments. The control section 22c in this embodiment has the execution processes in which the control section 22c controls the rectifying section 22e to decrease the output of the generated current Ix when the generated current Ix is larger than the load current Iy, the control section 22c controls the rectifying section 22e to keep the output of the generated current Ix as it is when the generated current Ix is equal to the load current Iy, and the control section 22c controls the rectifying section 22e to increase the generated current Ix when the generated current Ix is smaller than the load current Iy.

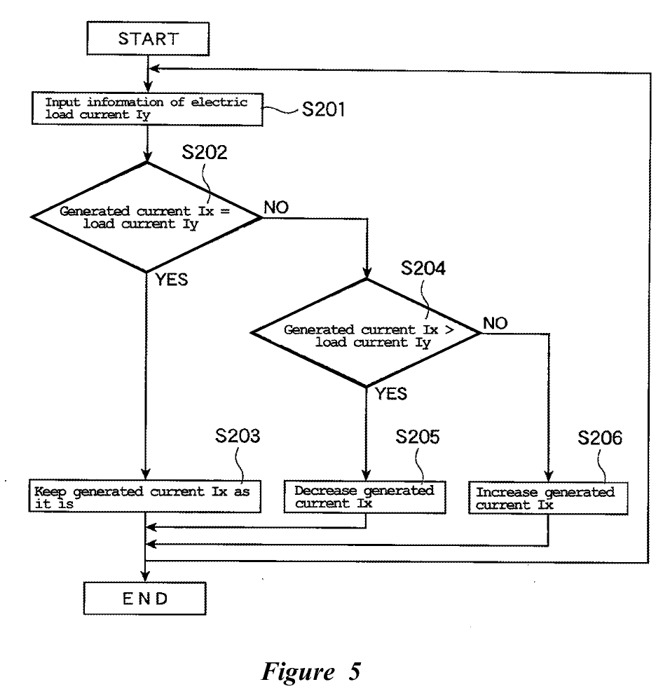

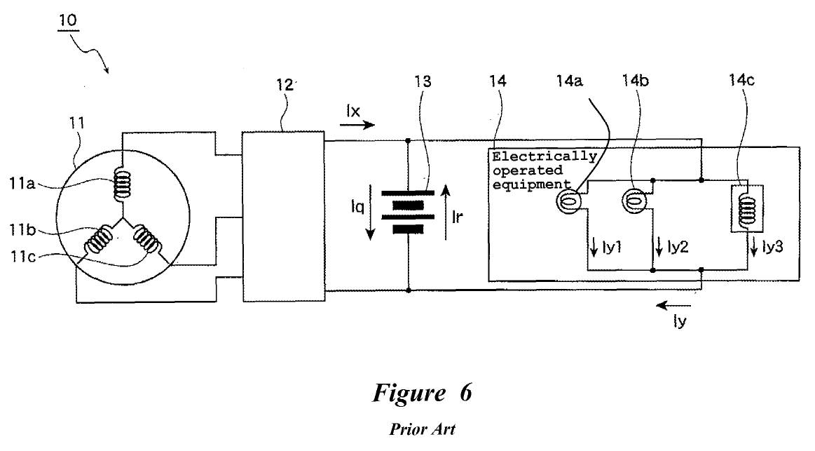

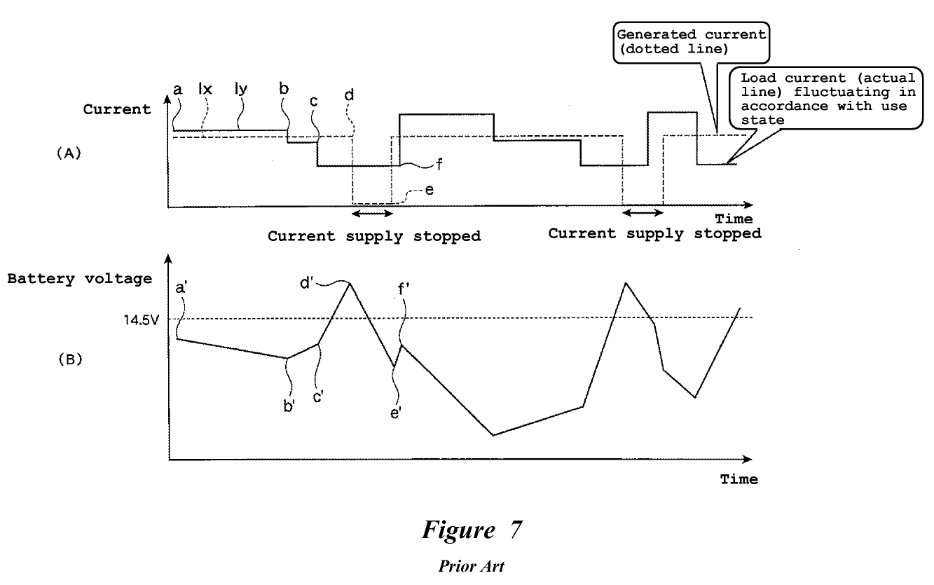

FIG. 5 is a flowchart showing execution processes of the control section 22c according to the illustrated embodiment.

First, as shown in FIG. 1, the load current detecting sensor 25a-25c detects individual load currents Iy1-Iy3 flowing through the electric equipment 23, and the load amount information calculating section 22d calculates a value of load current Iy summing up the individual load currents Iy1-Iy3 and inputs information of the load current Iy into the control section 22c (S201).

Next, the control section 22c determines whether the generated current Ix is equal to the load current Iy or not (step S202). If the generated current Ix is equal to the load current Iy, the control section 22c keeps the generated current Ix as it is (step S203). If the generated current Ix and the load current Iy are not equal to each other in the determination at the step S202, the control section 22c determines whether the generated current Ix is larger than the load current Iy or not (step S204). If the generated current Ix is larger than the load current Iy, the control section 22c decreases the generated current Ix. If the generated current Ix is smaller than the load current Iy in the determination at the step S204, the control section 22c increases the generated current Ix. The control section 22c, then, repeats the above steps. The program goes to the end if the power is off

In some of the embodiments disclosed above, the system can be structured such that a load current flowing through the electric device(s) is detected and, in the control section, the rectifying section can be controlled in such a manner that the generated current output from the rectifying section is generally equal to the fluctuating load current. Therefore, the control system can supply sufficient current to the electric device(s) and minimize any losses that arise with the horsepower generated in accordance with the engine operation, so that the fuel economy of the vehicle does not deteriorate.

In at least one embodiment, the generated current output from the rectifying section can be detected in addition to detecting the load current flowing through the electric device(s), and both of the currents can be input into the control section. Hence, the control section can provide feedback control that makes the load current and the generated current correspond to each other. The control section thus can accurately control the rectifying section so that the generated current output from the rectifying section is generally equal to the fluctuating load current. The control section, accordingly, can properly and precisely control the generated current to be generally equal to the fluctuated load current.

Additionally, in at least one embodiment, the control section can properly and rapidly supply an amount of the generated current output from the rectifying section that corresponds to a magnitude of the load current. Thus, unlike the conventional power generation control systems discussed above, no situation occurs where both the current generated by the magnet-type generator and the current generated by the battery needlessly flow through the circuit or that a current shortage occurs. The current generated by the magnet-type generator can thus be efficiently used for operating the electric device(s) using the battery-less power generation control system described above.

The present invention is not limited to the above embodiments, and various modifications can be made to the extent that the modifications are kept in the scope of the substance and the technical thought of the invention. For example, the manner in which the phase angle control is made is employed in the above embodiments. Alternatively, firing angle control can be employed. A micro-computer can be used as the control section.

The explanatory structure in which the total sum of the load currents flowing through the electric equipment is calculated by the load amount information calculating section positioned out of the control section is shown in the above embodiments. Alternatively, the system can be structured to calculate the total sum inside the control section.

The explanatory structure in which the load current flowing through the individual electric devices is detected by the current detecting sensors provided in the individual electric devices to calculate the total sum of the individual load currents is shown in the above embodiment. Alternatively, a current detecting sensor can detect the load currents flowing through the whole electric devices.

The present invention includes an embodiment in which the control section 22c is shown as one black box including the phase detecting circuit 22b, the load amount information calculating section 22d and the gate circuit 22e.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. A battery-less power generation control system, comprising:
a magnet-type generator driven at least by an internal combustion engine, the magnet-type generator configured to generate an alternating current;
a load current detecting sensor configured to detect a load current flowing through at least one electric device; and
a controller configured to rectify the generated alternating current to a generated direct current and to supply the generated direct current to the least one electric device, the controller comprising a rectifying section for converting the generated alternating current to the generated direct current and a control section for controlling the generated current output from the rectifying section, the control section configured to control the rectifying section so that the generated current output from the rectifying section is generally equal to the load current.

2. The battery-less power generation control system of claim 1, wherein
the battery-less power generation control system is configured to detect the generated current output from the rectifying section, and
the control section controls the rectifying section such that the generated current that is detected is generally equal to the load current.

3. The battery-less power generation control system of claim 2, wherein the control section is configured to control the rectifying section to decrease the generated current output by the rectifying section if a difference value calculated by subtracting the load current from the generated current exceeds a predetermined amount which is generally equal to the difference value, the control section further configured to control the rectifying section to maintain the generated current output if the difference value is equal to or less than the predetermined amount and is greater than zero, the control section further configured to control the rectifying section to increase the generated current if the difference value is a negative value.

4. The battery-less power generation control system of claim 2, wherein the control section is configured to control the rectifying section to decrease the generated current output if the generated current is larger than the load current, the control section further configured to control the rectifying section to maintain the generated current output if the generated current is equal to the load current, and the control section is further configured to control the rectifying section to increase the generated current if the generated current is smaller than the load current.

5. The battery-less power generation control system of claim 1, wherein the control section controls the rectifying section via a phase angle control.

6. A straddle type vehicle having the battery-less power generation control system according to claim 1.

7. A method for operating a battery-less power generation system, comprising:
detecting a load current flowing through at least one electrical component;
inputting the load current value into a controller;
determining whether a current generated by a generator is equal to or greater than the load current value;
determining whether a difference value calculated by subtracting the load current from the generated current is equal to or larger than a predetermined value if the generated current is equal to or greater than the load current value; and
increasing a supply amount of the generated current if the generated current is smaller than the load current.

8. The method of claim 7, further comprising decreasing a supply amount of the generated current if the difference value is equal to or larger than the predetermined value, and maintaining the supply amount of generated current if the difference value is smaller than the predetermined value.

9. The method of claim 8, further comprising, value after decreasing the supply amount of the generated current, determining whether the difference value is smaller than the predetermined, maintaining the supply amount of the generated current if the difference value is smaller than the predetermined value and further decreasing the supply amount of the generated current if the difference value is not smaller than the predetermined value.

10. The method of claim 7, wherein the at least one electrical component comprises a plurality of electrical components and inputting the load current includes inputting the summed total of the load current flowing through each of the plurality of electrical components.

11. A method for operating a battery-less power generation system, comprising:
detecting a load current flowing through at least one electrical component;
inputting the load current value into a controller;
determining whether the current generated by a generator is equal to the load current;
maintaining a supply amount of the generated current if the generated current is equal to the load current; and
determining whether the generated current is larger than the load current if the generated current is not equal to the load current.

12. The method of claim 11, further comprising decreasing the supply amount of the generated current if the generated current is larger than the load current, and increasing the supply amount of the generated current if the generated current is smaller than the load current.

13. The method of claim 11, wherein the at least one electrical component comprises a plurality of electrical components and inputting the load current includes inputting the summed total of the load current flowing through each of the plurality of electrical components.
